(19) United States
(12) Patent Application Publication
(10) Pub. No.: US 2005/0208348 A1
(43) Pub. Date: Sep. 22, 2005

(54) Air filtration system for fuel cell systems

(76) Inventor: Richard Thomas Canepa, Plymouth, MN (US)

Correspondence Address: MERCHANT & GOULD PC, P.O. BOX 2903, MINNEAPOLIS, MN, 55402-0903, US

(21) Appl. No.: 11/084,355

(22) Filed: Mar. 18, 2005

Related U.S. Application Data
(60) Provisional application No. 60/554,740, filed on Mar. 18, 2004.

(51) Int. Cl. B01D 50/00; H01M 8/00

(52) U.S. Cl. 429/12; 55/385.3

(57) ABSTRACT

A contamination control system for cathode intake air for fuel cell systems, particularly PEM fuel cell systems. The contamination control system incorporates three portions, particulate control, chemical contaminant control, and sound suppression or attenuation of the noise emitted by air handling equipment such as compressors, blowers, fans and expanders. At least one of these portions is designed and installed in the fuel cell system with the intent of lasting the life of the system. In a preferred system, a z-filter configured for straight-through flow is permanently installed in an automobile.

Priority under 35 U.S.C. § 119(e) is claimed to U.S. provisional application no. 60/554,740, filed Mar. 18, 2004. The complete disclosure of provisional application no. 60/554,740 is incorporated herein by reference.

### FIELD OF THE DISCLOSURE

The present disclosure is related to air filtration systems for removing contaminants from cathodic intake air for fuel cell systems. In particular, the contamination control system provides particulate filtration, chemical contaminant filtration, and sound suppression or attenuation in the cathodic air stream.

### BACKGROUND

When ambient air is used as a source of oxygen for the cathode in fuel cells, the life, durability and performance of the fuel cells can be greatly affected by the quality of the air. The cathode catalyst and the electrolyte can be temporarily or permanently poisoned or damaged by contaminants that are present in the atmosphere such as sub-micrometer particulate matter, sulfur compounds, VOCs, salts and NH, etc. The concentration and type of these atmospheric contaminants vary with location, time of day and season. The removal of these contaminants is beyond the capability of current air contamination control systems (particulate-filters) used in power plants such as engines and gas turbines. Therefore, to maximize the performance, life and durability of PEM fuel cells, a new class of air contamination control is required.

Donaldson Company has developed various systems and arrangements to provide a source of acceptable, cleansed, air for fuel cell systems. See for example, U.S. Pat. Nos. 6,432,177 and 6,638,339 (Dallas et al.), U.S. Pat. Nos. 6,780,534, 6,783,881 and 6,797,027 (Stenersen et al.), and U.S. patent application Ser. No. 10/241,117 (filed Sep. 10, 2002) (Stenersen et al.). Each of these patents and application is incorporated herein by reference for all of their teachings. These systems provide multiple functions (e.g., particulate filtration, chemical filtration, sound suppression, water management, etc.) within a single unit or multiple units.

There exists a desire for continued advancement and alternate designs for fuel cell cathode air filtration.

### SUMMARY OF THE DISCLOSURE

The present disclosure is to a contamination control system for cathode intake air for fuel cell systems, particularly PEM fuel cell systems. The contamination control system incorporates three portions, particulate control, chemical contaminant control, and sound suppression or attenuation of the noise emitted by air handling equipment such as compressors, blowers, fans and expanders. The various portions of the system can be defined as intake components, which are positioned up-stream of the air-handling equipment, and discharge components, which are downstream of the air-handling equipment. At least one of these portions, if not all, are designed and installed in the fuel cell system with the intent of lasting the life of the system.

A typical fuel cell system is a motor vehicle (i.e., an automobile) powered by a PEM fuel cell. In one embodiment, the present contaminant control system provides a particulate filtration portion that will last the expected life of the automobile, e.g., 10 years or 150,000 miles. In another embodiment, the particulate filtration portion will last 15 years or 250,000 miles.

In one particular aspect, this invention is directed to a fuel cell system that includes an automobile, a fuel cell configured to provide electrical power to the automobile, and a contamination control system mounted in the automobile upstream of the fuel cell in the air stream. The contamination control system has a particulate z-filter configured for straight-through flow from a first flow face to a second flow face, with the filter comprising cellulosic filtration media and nanofiber media. The contamination control system also has a chemical adsorbent filter configured for straight-through flow from a first flow face to a second flow face. A silencer may also be present. In one embodiment, at least one of the particulate filter and the chemical adsorbent filter is mounted in an inner fender compartment of the automobile. In another embodiment, at least one of the particulate filter and the chemical adsorbent filter is permanently fixed within the automobile.

The disclosure includes various other embodiments.

### BRIEF DESCRIPTION OF THE DRAWING

FIG. 1 is a front perspective view of a portion of an automotive compartment, which includes therein a first embodiment of a contamination control system according to the present invention for an automotive cathodic intake air for a fuel cell.

FIG. 2 is a rear perspective view of the portion of the automotive compartment of FIG. 1.

FIG. 3 is a front perspective view of a portion of an automotive compartment, which includes therein a second embodiment of a contamination control system according to the present invention for an automotive cathodic intake air for a fuel cell.

FIG. 4 is a perspective view of one embodiment of a particulate filter suitable for use in the system of the present invention.

FIG. 5 is a perspective view of a first embodiment of a chemical contaminant removal filter suitable for use in the system of the present invention.

FIG. 6 is a perspective view of a second embodiment of a chemical contaminant removal filter suitable for use in the system of the present invention.

FIG. 7 is a perspective view of a third embodiment of a chemical contaminant removal filter suitable for use in the system of the present invention.

### DETAILED DESCRIPTION

The contamination control system of this disclosure is used to remove contaminants from ambient air being used by the cathode side of a fuel cell (such as a PEM fuel cell) in a fuel cell system. One typical fuel cell system is a motor vehicle (e.g., an automobile) powered by a PEM fuel cell

The contaminant control system of this disclosure includes various components that, together, are beneficial for fuel cell performance. These components include at least one particulate filtration portion, at least one chemical contaminant filtration portion, and air-handling equipment, such as a compressor, all of which are positioned up-stream of the fuel cell. The portions of the contamination control system can be divided into two categories: (1) intake components, which include components configured to be positioned up-stream of the air-handling compressor and (2) discharge components, which are configured downstream, or on the pressure side, of the air-handling compressor.

The intake components are positioned and designed to remove contaminants from incoming ambient air that might be harmful to the downstream fuel cell, and to attenuate noise emitted from the intake of the air-handling compressor. The intake components are positioned in the air stream, before the air-handling compressor.

The discharge components are positioned and designed to minimize or otherwise break up the pressure pulses from the compressor discharge, attenuate noise emitted by the compressor discharge, cool the compressed air, and to remove contaminants emitted by the compressor or any other air handling components in the system.

The contamination control system and its various components are described with reference to the accompanying figures.

Contamination Control System

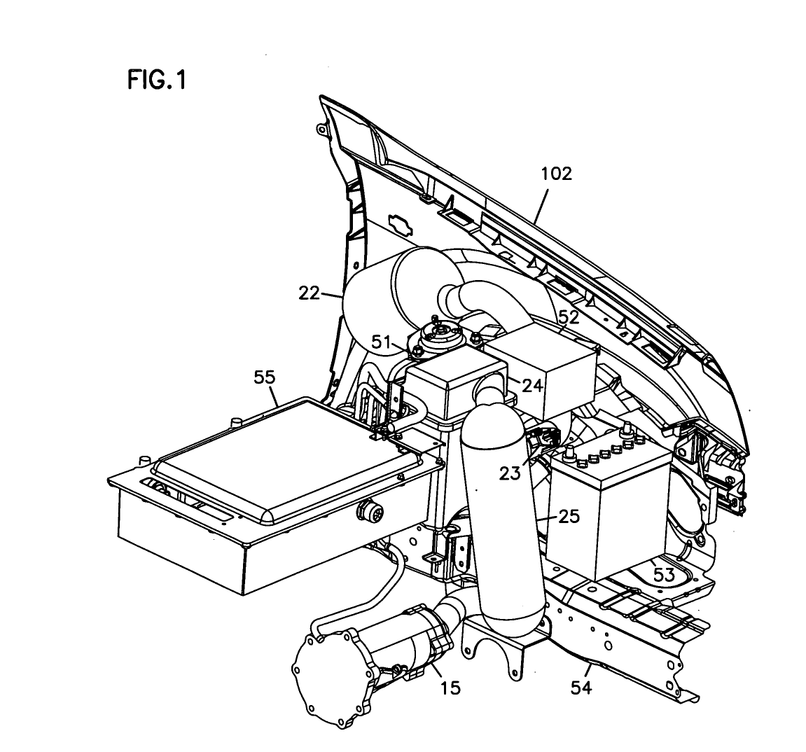

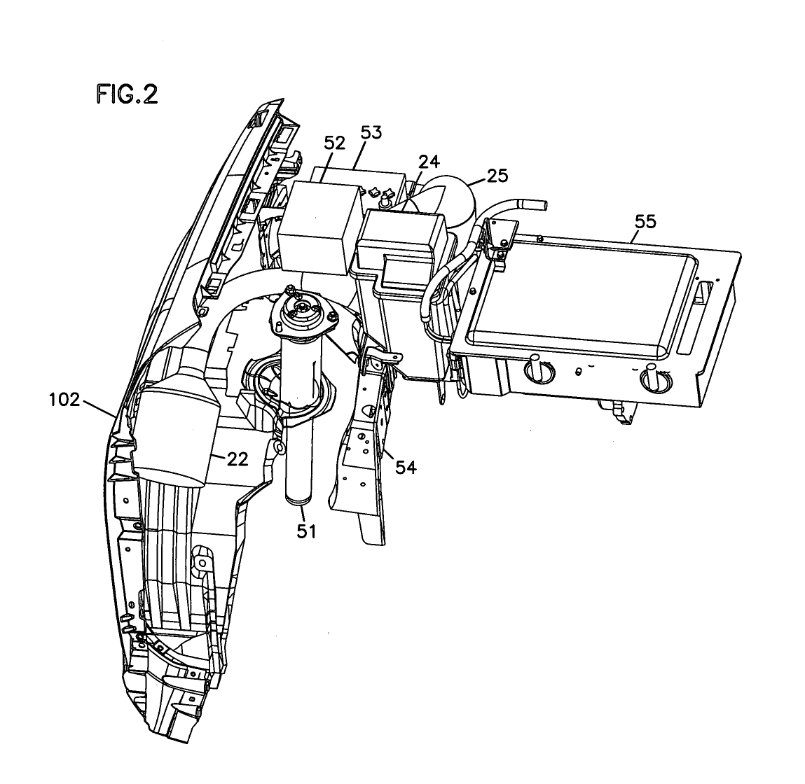

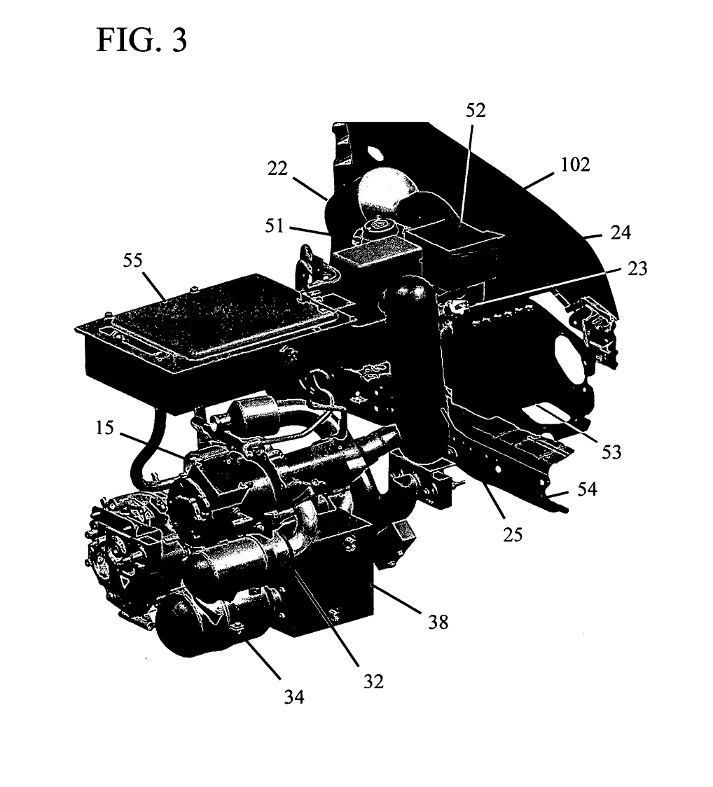

Referring to FIGS. 1, 2 and 3, a portion of an automotive compartment is illustrated. If this were a conventional automobile having a combustion engine, the compartment illustrated would be referred to as a front engine compartment. However, the automobile this portion represents is powered by a fuel cell system; the fuel cell is often positioned either below the passenger compartment or at the back of the vehicle. Using a fuel cell in an automobile has spawned a new configuration for automobiles and the position of various systems, such as the power-producing system, which, in a fuel cell powered automobile, is the fuel cell. As stated above, the fuel cell is generally no located in the convention “engine compartment”, but is either below the passenger compartment or behind it. Thus, the compartment illustrated in FIGS. 1, 2 and 3 should not properly be referred to as an engine compartment, and so, within this disclosure, this compartment will be referred to merely as “a compartment”. The view of FIGS. 1 and 3 is generally from the front of the automobile, and the view of FIG. 2 is generally from the passenger compartment of the automobile.

In FIGS. 1, 2 and 3, the compartment illustrated is partially defined by exterior fender 102, which is the exterior fender of the automobile. To facilitate understanding of the contamination control systems of the present invention, not illustrated in FIGS. 1, 2 and 3 is the interior fender, which would be present between the exterior fender and the compartment. The exterior fender and the interior fender define a hidden compartment above the wheel well. Typically, this hidden compartment is not accessible in ordinary use of the vehicle.

In FIGS. 1 and 2 and FIG. 3, various elements of a fuel cell system are illustrated, the particular fuel cell system being an automobile. Also illustrated are contamination control systems according to the present invention. In FIGS. 1 and 2, a first embodiment of a contamination control system is shown, and in FIG. 3, a second embodiment of a contamination control system is shown. Such contamination control systems are used in combination with a fuel cell, which requires air, or another source of oxygen, to operate. A compressor or other air-handling equipment is used to supply the desired amount of air. The fuel cell is not illustrated in the figures, the fuel cell being, as stated above, located elsewhere in the vehicle.

Illustrated in FIGS. 1 and 2 are various elements, including those of the contamination control system, a compressor 15, and various automotive structural and operational elements, such as fender 102, suspension equipment 51 (such as a strut), electrical component container 52, DC battery 53, frame support 54, and drive system 55. The automotive structural and operational elements are illustrated to show the reader the tight configuration within the compartment, and to illustrate how the various elements of the contamination control system fit within the compartment.

Illustrated in FIG. 3 are also various elements, including those of the contamination control system, compressor 15, and various automotive structural and operational elements, such as fender 102, suspension equipment 51 (such as a strut), electrical component container 52, DC battery 53, frame support 54, and drive system 55.

As is well known, air enters the fuel cell at its cathode inlet. Prior to reaching the cathode inlet, however, the air passes through the inventive contamination control systems and compressor 15, as well as other optional equipment such as mass air flow sensors, pressure sensors, humidifiers, and heat exchangers. The following discussion referred to both exemplified contamination control systems, that of FIGS. 1 and 2 and that of FIG. 3. The same reference numerals are used to represent like parts in both embodiments.

As mentioned above, each contamination control system has portions that provide particulate control, chemical contaminant control, and sound suppression or attenuation of the noise emitted by compressor 15. The various portions of the system can be defined as intake components, which are positioned up-stream of compressor 15, and discharge components, which are downstream of compressor 15 between compressor 15 and the fuel cell.

Intake Components

The contamination control system includes various portions positioned upstream of compressor 15 which act upon the incoming air; these portions are referred to as part of the intake component system. The intake component system includes a particulate filter or portion 22 and a chemical contaminant filter or portion 24. The intake component system also includes an intake silencer 25. An air-mass-flow sensor 23 is shown present in the intake component system, positioned between particulate filter 22 and chemical filter 24.

Particulate Filter

Ambient air enters and passes through particulate filter 22, which removes particulate matter from the air stream. It should be understood that in FIGS. 1 through 3, reference numeral 22 is pointing to a housing in which the actual particulate filter element is positioned.

Particulate filter 22 is a fluted, in-line or z-filter, one which has generally straight-through flow. Examples of such filters are described in, for example, U.S. Pat. Nos. 5,820,646, 5,772,883, 6,190,432, 6,350,291, Des. 396,098, Des. 398,046, Des. 461,003, Des. 461,884, (all incorporated herein by reference) and available from Donaldson Company under the designation “PowerCore” filters. Filters with straight-through flow could be made as described in U.S. Pat. Nos. 5,543,007 and 5,435,870 (which are also incorporated herein by reference).

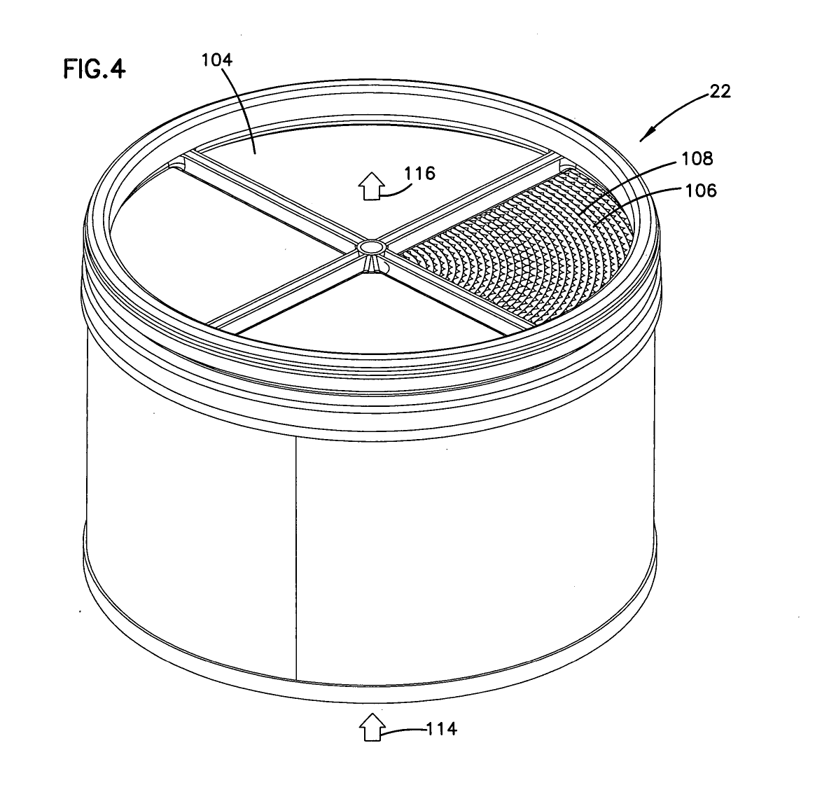

By “straight-through flow” it is meant that filter 22 is configured to have a first flow face corresponding to an inlet end and an opposite, second flow face corresponding to an outlet end. See FIG. 4, which illustrates a preferred embodiment of a fluted filter configured for straight-through flow. Straight-through flow is often desired because a straight-through flow filter can handle greater amounts of air passing therethrough compared to, for example, a pleated filter. It is intended that there is no distinction between “straight-through flow”, “in-line flow”, and variations thereof. Air enters filter 22 in one direction through first flow face 102, represented by arrow 114, and exits in the same direction from second flow face 104, represented by arrow 116. First flow face 102 correlates to the dirty air side of filter 22 and second flow face 104 correlates to the clean air side of filter 22. First flow face 102 and second flow face 104 may be planar and parallel, may be planar and non-parallel, or either or both faces 102, 104 may be non-planar (for example, frusto-conical). Although first flow face 102 is described above as corresponding to an inlet end (and dirty air side), and second flow face 104 is described above as corresponding to an outlet end (and clean air side), the inlet and outlet ends (and dirty air side and clean air side) can be reversed.

In a preferred embodiment for straight-through flow, the media of particulate filter 22 is a wound or rolled construction. That is, particulate filter 22 includes a layer of filtration media that is wound completely or repeatedly about a central axis. Typically, the wound construction is a coil, in that a layer of filtration media is rolled in a series of turns around a central axis. In arrangements where a wound, coiled construction is used, particulate filter 22 will be in the shape of a roll of filtration media, typically permeable fluted filtration media. Preferred shapes for particulate filter 22 include round, oval, elliptical, racetrack shape, and other obround shapes.

The fluted filtration media includes a corrugated layer defining a plurality of flutes and a face sheet, which is typically planar. When using this type of fluted filtration media, flute chambers are formed by alternating peaks and troughs of the corrugated layer. The peaks and troughs divide the flutes into two collections. The flutes in the first collection 106 (see FIG. 4) are closed at the upstream end (at first face 102), while the flutes in the second collection 108 have the downstream end (at second face 104) closed. The flutes are typically closed and sealed by adhesive.

During use, unfiltered air enters the flute chambers of second collection 108 at first face 102. The flute chambers of second collection 108 have their upstream ends open. The unfiltered air flow is not permitted to pass through downstream ends of the flutes of second collection 108 because their downstream ends are closed. Therefore, the air is forced to pass through the corrugated sheet or the face sheet at some location between first face 102 and second face 104. As the unfiltered air passes through the corrugated sheet or the face sheet, the air is cleaned or filtered. The air then continues through the flute chambers of the first collection 106 (which have their upstream ends closed) to flow through the open downstream ends.

Various additional details regarding z-filters or straight-through filters and methods of making those filters are provided in those patents incorporated by reference above.

The filtration media from which particulate filter 22 is formed may be treated in any number of ways to improve its efficiency in removing minute particulates; for example, electrostatically treated media can be used, as can cellulose or synthetic media or a combination thereof, having one or more layers of nanofiber, or other types of media known to those skilled in the art. For details regarding types of nanofiber that could be used, see for example, U.S. Pat. No. 4,650,506. A nanofiber material is available from Donaldson Company under the mark “Ultraweb” media. “Ultraweb” media includes microscopic (e.g., nanometer size) fibers present as a layer over larger (e.g., cellulosic) fibers.

Nanofibers, particularly those under the “Ultraweb” mark, provide high filtration efficiency of very small particles, such as Diesel soot. “Ultraweb” fibers also inhibit the passage of salt through the filtration media.

PTFE (polytetrafluoroethylene) is also a suitable additive or additional layer over cellulosic media. Expanded PTFE membranes are desired as they inhibit salts and petroleum products such as oils to penetrate therethrough.

Chemical Filter

he air, preferably already filtered by particulate filter 22, enters and passes through chemical filter 24, which removes airborne chemical contaminants from the air stream. Filter 24 is configured to remove acidic contaminants, basic contaminants, organics, carbonyl-containing compounds, and any combination thereof. It should be understood that in FIGS. 1 through 3, reference numeral 24 is pointing to a housing in which the actual chemical filter is positioned.

Chemical filter 24 may be any suitable adsorption or absorption filter, such as a packed bed or immobilized mass of adsorptive material; however, chemical filter 24 is preferably a low pressure-drop filter.

Examples of one type of preferred low-pressure drop filter are disclosed in U.S. Pat. No. 6,645,271, which is incorporated herein by reference. These adsorbent filter elements have an adsorptive coating present on a substrate, the substrate having a plurality of passages therethrough. Air passes through the passages, in generally straight-through flow, and contaminants present in the air adsorb or absorb onto, or react with, the coating. The adsorptive coating can be acidic, to remove basic contaminants, or basic, to remove acidic contaminants. U.S. patent application Ser. No. 10/947,732 (filed Sep. 23, 2004), also incorporated herein by reference, has a similar construction, but is adapted for removal of carbonyl-containing compounds.

Other examples of preferred low-pressure drop filter are disclosed in U.S. patent applications Ser. No. 10/928,776 (filed Aug. 27, 2004), 10/927,708 (filed Aug. 17, 2004), and 11/016,013 (filed Dec. 17, 2004), all which are incorporated herein by reference. These applications are directed to adsorbent filter elements that use fibrous filtration media impregnated with various active ingredients, configured to adsorb, absorb or otherwise remove the desired contaminants. Air passes through these filter elements with generally straight-through flow. Various examples of such low pressure-drop filters are available from Donaldson Company under the designation “Wizard” filter elements. Various embodiments are described below.

FIG. 5 illustrates a first embodiment of a chemical filter having straight-through flow. In FIG. 5, chemical filter 24A has a first flow face 121 and a second flow face 122 separated by distance L. Extending from first flow face 121 to second flow face 122 are a plurality of passages 125 defined by facing sheet 123 and corrugated sheet 124.

In use, air to be cleansed passes through passages 125 and contaminants are absorbed or adsorbed by material either impregnated into or coated on facing sheet 123 and corrugated sheet 124.

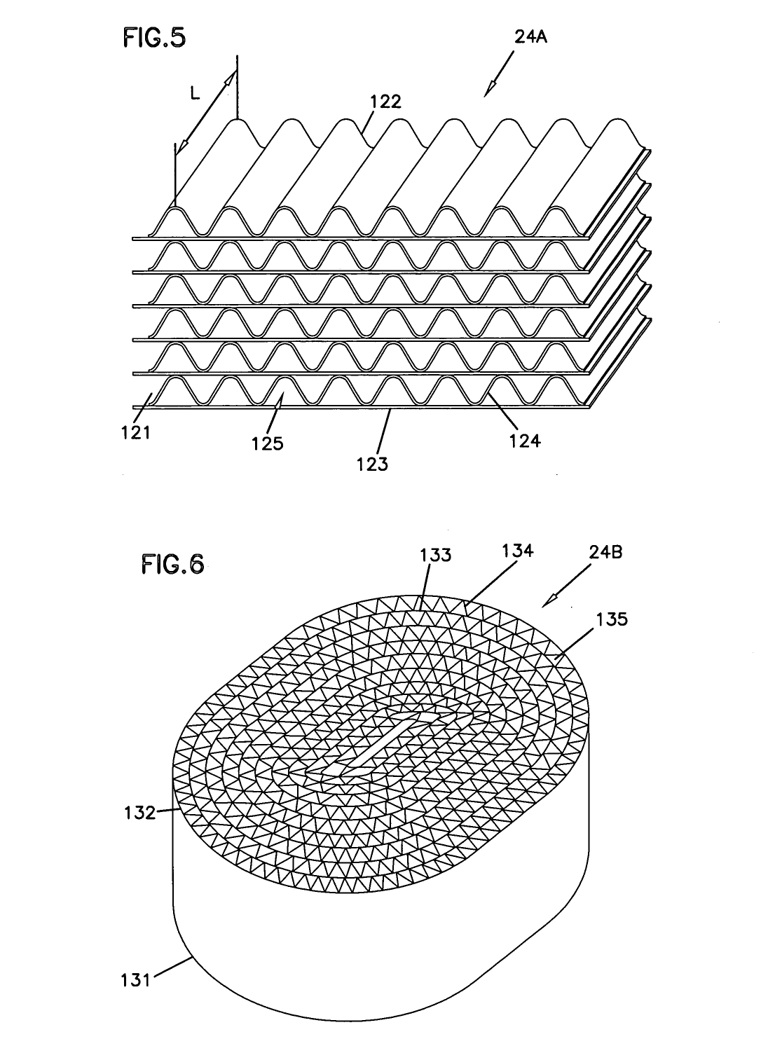

FIG. 6 illustrates a second embodiment of a chemical filter having straight-through flow. In FIG. 6, chemical filter 24B has a first flow face 131 and a second flow face 132. Extending from first flow face 131 to second flow face 132 are a plurality of passages 135 defined by facing sheet 133 and corrugated or folded sheet 134. Facing sheet 133 and folded sheet 134 are coiled to form filter 24B.

In use, air to be cleansed passes through passages 135 and contaminants are absorbed or adsorbed by material either impregnated into or coated on facing sheet 133 and corrugated sheet 134.

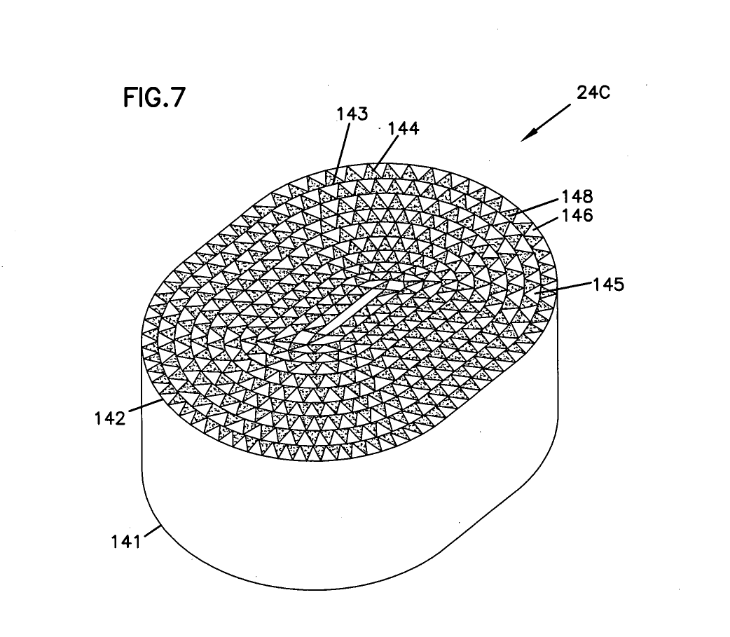

FIG. 7 illustrates a third embodiment of a chemical filter having straight-through flow. In FIG. 7, chemical filter 24C has a first flow face 141 and a second flow face 142. Extending from first flow face 141 to second flow face 142 are a plurality of passages 145 defined by facing sheet 143 and corrugated or folded sheet 144. Facing sheet 143 and folded sheet 144 are coiled to form filter 24C.

Flutes 145 in a first collection 146 are closed at first face 141 while flutes 145 in a second collection 148 are closed at second face 142. Flutes 145 are typically closed and sealed by adhesive.

In use, air to be cleansed passes through passages 145 and contaminants are absorbed or adsorbed by material either impregnated into or coated on facing sheet 143 and corrugated sheet 144. Additionally, the air is not permitted to pass through downstream ends of flutes 145, for example of second collection 148 because their downstream ends are closed at second flow face 142. Therefore, the air is forced to pass through facing sheet 143 or corrugated or folded sheet 144 at some location between first face 141 and second face 142.

Chemical filter 24 may include more than one of these previously described low-pressure drop filter elements. For example, three different elements (placed in series) may be used: one adapted for acid contaminant removal, one adapted for basic contaminant removal, and one adapted for carbonyl-compound removal.

Chemical filter 24 could alternately be a mass of adsorbent material shaped into a monolithic or unitary form, such as, for example, a large tablet, granule, bead, or pleatable or honeycomb structure that optionally can be further shaped. The shaped adsorbent material substantially retains its shape during the normal or expected lifetime of the contamination control system. The shaped adsorbent material can be formed from a free-flowing particulate material combined with a solid or liquid binder that is then shaped into a non-free-flowing article. The shaped adsorbent material can be formed by, for example, a molding, a compression molding, or an extrusion process. Shaped adsorbent articles are taught, for example, in U.S. Pat. No. 5,189,092 (Koslow), and U.S. Pat. No. 5,331,037 (Koslow), which are incorporated herein by reference.

The binder used for providing shaped articles can be dry, that is, in powdered and/or granular form, or the binder can be a liquid, solvated, or dispersed polymer. “Hot melt” binder can be used. As is understood by those in the art of molding and extrusion, different techniques will be used for forming the shaped adsorbent, depending on the binder or matrix used. A carrier material, such as a scrim or mesh, can be used to hold the adsorbent material together.

Chemical filter 24, made with shaped adsorbent materials, is generally able to withstand vibration forces that may be the result of air moving equipment, such as a compressor 15, or typical vehicle vibration forces, such as those due to rough roads on which the vehicle might be traveling.

Intake Air Silencer

The air, preferably already filtered by particulate filter 22 and chemical filter 24, enters and passes intake silencer 25, which is close-coupled to the compressor intake. Silencer 25 is preferably designed to decrease, and preferably eliminate, noise at frequencies from 100 Hz to 35 KHz. A particular desire is to decrease the fundamental frequencies of compressor 15 experienced throughout the fuel cell system's functional operating range. For a typical automotive fuel cell system, the typical operating range is 100 Hz at idle and 1,200 Hz at maximum power.

Although the term “silencer” is used, silencer 25 can be any of a resonator, such as a Helmholz resonator, an attenuator, a sound absorber, or a muffler. Particular details regarding designs of silencer 25 are discussed in U.S. Pat. Nos. 6,780,534, 6,783,881 and 6,797,027, all which are incorporated herein by reference.

Permanently Hidden System

In accordance with the present disclosure, at least a portion of the contamination control system is permanently affixed within a compartment of the fuel cell system, the compartment being not generally accessible under normal operating conditions. At least one of particulate filter 22, chemical filter 24 and intake air silencer 25 are permanently affixed. Although the term “permanently affixed” is used, it is not intended that the portion is not physically removable from its location, such as when the fuel cell system is disassembled. Rather, what is intended is that the permanent portion is not intended to be removed and replaced during the life of the fuel cell system. It may in fact be possible to physically remove the portion, however, there is no need to do so. Typically it is one or both of particulate filter 22 and chemical filter 24 that are permanent.

In one embodiment, the fuel cell system is a fuel cell powered automobile and the contamination control system is part of that automobile. The life of a typical automobile is currently 150,000 miles, although it is expected this lifespan will increase as technology in automobiles advances.

In a preferred design, the contamination control system is positioned within an automobile, and particulate filter 22 is located inside an inner fender compartment of the automobile, that is, between exterior fender 102 and the interior fender, which together define a hidden inner fender compartment above the wheel well. Particulate filter 22 is generally hidden from view within the inner fender compartment. Particulate filter 22 is configured and designed to not be removed or replaced. Particulate filter 22 is configured and designed to last the life of the automobile. Particulate filter 22 has various characteristics which are particularly suited for adapting filter 22 to long range use, i.e., the life of the fuel cell system.

As discussed above, particulate filter 22 has a straight-through flow for air being filtered. The fluted configuration of straight-through flow particulate filter 22 provides the benefit of very high dust holding capacity. The addition of nanofibers on the filtration media further increase the surface loading of the dust or other particulate contaminant on the filtration media.

In a preferred installation, particulate filter 22 is positioned so that first flow face 102, or the inlet or dirty air end, is positioned slightly lower, or pointing slightly downward, than second flow face 104, or the outlet or clean air end. With such a position, dust collected by particulate filter 22 will tend to shed off and out from filter 22, at least due to gravity. Additionally, vibration, due to vibration of the automobile, such as due to compressor 15, loosens the dust and particulate, facilitating shedding. Operating the automobile on rough roads further facilitates the shedding of dust and particulates from filter 22, often simulating a pulse effect.

Various features of the intake component system have been described above. The intake component system, having particulate filter 22, chemical filter 24, and silencer 25, offer a fuel cell system, particularly a fuel cell powered automobile, a high level of protection from ambient air contaminants at low air flow restriction. The particular combination of straight-through flow for particulate filter 22 and low pressure drop elements for chemical filter 24 facilitate the low restriction.

Discharge Components

The contamination control system includes various portions positioned downstream of compressor 15 which act upon the air, after it has passed through compressor 15 but before it reaches the fuel cell. These portions are referred to as part of a discharge component system. In the embodiment illustrated in FIG. 3, the discharge component system includes a first silencer 32, a second silencer 34, a discharge filter 36, and cooler 38.

Discharge Silencers

The discharge air from compressor 15 enters first silencer 32, which is close-coupled to compressor 15. First silencer 32 preferably is hard mounted to compressor 15 without any flexible couplings. The air then progresses to second silencer 34, which is coupled first silencer 32, such as with a stainless steel bellows, to compensate for any movement between the two silencers 32, 34. The bellows is also structurally able to prevent excessive shell noise to be transmitted by the coupling, which is the case for any rubber-based couplings.

Silencers 32, 34 are designed to equal out pressure pulses emitted by the compressor through a series of expansion chambers and tube perforations. The noise emitted is attenuated through a series of resonators, expansion chambers and through absorptive material. Any subsequent component down-stream of silencers 32, 34 will not suffer from shell noise or any other problem due to compressor noise or pressure pulses.

Downstream of silencers 32, 34 may be an after-cooler 38 to reduce the temperature of the compressed air.

Discharge Filter

From silencers 32, 34, and optionally from any after-cooler 38, the compressed air progresses to a final filter, discharge filter 36. Final filter 36 is configured to remove any final contaminants, both particulate and chemical, that may be present in the air stream. Final filter 36 is preferably specifically designed to inhibit passage of any oil that may have been introduced into the air stream by compressor 15. Expanded PTFE is a preferred material for final filter 36 for removal of oil, salts, and particulates.

The foregoing description, which has been disclosed by way of the above discussion and the drawing, addresses embodiments of the present disclosure encompassing the principles of the present invention. The embodiments may be changed, modified and/or implemented using various types of arrangements. Those skilled in the art will readily recognize various modifications and changes which may be made to the described systems without strictly following the exemplary embodiments illustrated and described herein, and without departing from the scope of the present invention which is set forth in the following claims. All patents referred to herein are incorporated by reference herein in their entirety.

1. A fuel cell system comprising:
(a) an automobile;
(b) a fuel cell having an anode and a cathode, the cathode adapted to receive an air stream, the fuel cell configured to provide electrical power to the automobile;
(c) a contamination control system mounted in the automobile upstream of the fuel cell in the air stream, the contamination control system comprising:
(i) a particulate z-filter configured for straight through flow from a first flow face to a second flow face, the filter comprising cellulosic filtration media and nanofiber media;
(ii) a chemical adsorbent filter configured for straight through flow from a first flow face to a second flow face; and
(iii) a silencer;
(d) a compressor positioned upstream of the fuel cell;
(e) at least one of the particulate filter and the chemical adsorbent filter mounted in an inner fender compartment of the automobile.

2. The system according to claim 1, wherein the particulate filter is mounted in the inner fender compartment.

3. The system according to claim 2, wherein the particulate filter is mounted with the first flow face lower than the second flow face.

4. The system according to claim 2, wherein the particulate filter and the chemical adsorbent filter are mounted in an inner fender compartment

5. The system according to claim 2, wherein the particulate filter is upstream of the chemical adsorbent filter.

6. The system according to claim 1, wherein each of the particulate filter, chemical adsorbent filter and silencer are upstream of the compressor.

7. The system according to claim 6, further comprising a discharge filter downstream of the compressor and upstream of the fuel cell.

8. The system according to claim 7, wherein the discharge filter comprises PTFE.

9. A fuel cell system comprising:
(a) an automobile;
(b) a fuel cell having an anode and a cathode, the cathode adapted to receive an air stream, the fuel cell configured to provide electrical power to the automobile;
(c) a contamination control system mounted in the automobile upstream of the fuel cell in the air stream, the contamination control system comprising:
(i) a particulate z-filter configured for straight through flow from a first flow face to a second flow face, the filter comprising cellulosic filtration media and nanofiber media;
(ii) a chemical adsorbent filter configured for straight through flow from a first flow face to a second flow face; and
(iii) a silencer; and
(d) a compressor;
(e) at least one of the particulate filter and the chemical adsorbent filter permanently fixed within the automobile.

10. The system according to claim 9, wherein the particulate filter is permanently fixed within the automobile.

11. The system according to claim 10, wherein the particulate filter is mounted in the inner fender compartment.

12. The system according to claim 10, wherein the particulate filter is mounted with the first flow face lower than the second flow face.

13. The system according to claim 10, wherein the particulate filter is upstream of the chemical adsorbent filter.

14. The system according to claim 10, wherein each of the particulate filter, chemical adsorbent filter and silencer are upstream of the compressor.

15. The system according to claim 10, further comprising a discharge filter downstream of the compressor and upstream of the fuel cell.

16. The system according to claim 15, wherein the discharge filter comprises PTFE.
